(19) United States
(12) Patent Application Publication
(10) Pub. No.: US 2022/0135318 A1
(43) Pub. Date: May 5, 2022

(54) TRASH BIN AND ASSOCIATED METHOD

(71) Applicant: Cintas Corporate Services, Inc., Cincinnati, OH (US)

(72) Inventors: Richard R. Bing, West Chester, OH (US); Megan Kathryn Helms, Hamilton, OH (US); David Steven Mesko, Wyoming, OH (US); Michael E. Berger, Brooklyn, NY (US); Adem Önalan, Jersey City, NJ (US); Marco C. Perry, Brooklyn, NY (US)

(21) Appl. No.: 17/392,647

(22) Filed: Aug. 3, 2021

Related U.S. Application Data
(60) Provisional application No. 63/109,892, filed on Nov. 5, 2020.

(51) Int. Cl. B65F 1/06; B65F 1/14

(52) U.S. Cl. CPC B65F 1/062; B65F 1/1415

(57) ABSTRACT

A trash bin is used in combination with a liner for various purposes, including the collection and disposal of trash. The trash bin has an outer bin, an inner bin, a lid assembly and a liner box mounted on a bottom end of an interior chamber of the trash bin. The liner box houses a roll of liners which can be pulled from a leading end of the roll to position the leading liner of the roll in the trash bin. After the liner is filled with trash, a user may pull the filled liner from the trash bin and by doing so pulls the next liner from the roll in the liner box for subsequent separation from the filled liner and installation in the trash bin for filling with trash.

This claims the benefit of U.S. Provisional Patent Application Ser. No. 63/109,892, filed Nov. 5, 2020 and hereby incorporated by reference in its entirety.

### BACKGROUND OF THE INVENTION

This invention relates to the field of trash receptacles that utilize bag liners and is directed to several problems that have long existed in that field.

Trash receptacles come in a variety of shapes and sizes and are commonly used in domestic, commercial and industrial applications. To avoid contamination of the interior of such receptacles, a plastically deformable liner bag is usually inserted into the receptacle, such that the liner covers the sidewalls and bottom of the receptacle and extends around the perimeter of the receptacle opening. As the liner bag is filled with trash, it is compressed against the sides and bottom of the receptacle. Once the liner bag is full, a user pulls the liner bag from the receptacle through the upper opening of the receptacle and ties off the open mouth of the liner bag for disposal of the filled liner bag. Then, the user must install a new liner bag in the receptacle for future use.

Commonly, multiple liner bags are formed in a roll and connected serially one to another by a line of perforations between the adjacent liner bags in the roll. The user pulls the leading liner bag from the roll until the perforation line connecting the leading liner bag to the next trailing liner bag is exposed for tearing to separate the leading liner bag from the roll. Then the separated liner bag must be expanded and inserted into the trash receptacle for future trash collection. The user must bend over and/or reach into the trash receptacle to properly install the expanded liner bag therein. The user must also secure the liner bag to the trash receptacle in some manner so that it does not fall to the bottom of the trash receptacle when trash is deposited therein. When this happens, the liner does not protect the inside of the receptacle and the receptacle may be rendered unsanitary, particularly in cases where liquid waste is involved, so that the receptacle normally must be manually cleaned.

The process of removing a filled liner bag, installing a new liner bag in the trash receptacle and securing it thereto is often awkward, cumbersome and requires exposure to the often unsanitary interior of the trash receptacle.

An improved approach is needed in a trash receptacle that provides for easy removal of trash liner bags and installation of a new liner bag therein.

### SUMMARY OF THE INVENTION

These and other shortcomings in the prior art have been addressed by this invention, which in various embodiments is a trash bin used in combination with a liner for various purposes, including the collection and disposal of trash. The trash bin according to one embodiment of this invention has an outer bin, an inner bin, a lid assembly and a liner box mounted on a bottom end of an interior chamber of the trash bin. The liner box houses a roll of liners which can be pulled from a leading end of the roll to position the leading liner of the roll in the trash bin. After the liner is filled with trash, a user may pull the filled liner from the trash bin and by doing so pulls the next liner from the roll in the liner box for subsequent separation from the filled liner and installation in the trash bin for filling with trash.

Accordingly, a user of this invention can conveniently place a liner in the trash bin for collection of trash, remove the liner once filled with trash and replace the filled liner with a fresh liner without reaching down into the trash bin and being exposed to the interior contents of the trash bin and associated refuse remains and contaminants therein.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a perspective view of one embodiment of a trash bin according to this invention;

FIG. 2 is an exploded perspective view of the components of the trash bin of FIG. 1;

FIGS. 2A-2B are perspective views of a liner box in open and closed configurations, respectively, of the embodiment of FIGS. 1-2;

FIG. 3 is a cross-sectional view taken along line 3-3 of FIG. 1 showing a roll of liners being inserted into an open liner box;

FIG. 3A is an enlarged view of the open liner box of FIG. 3;

FIG. 4 is a view similar to FIG. 3 with the liner roll installed in and being dispensed from the closed liner box;

FIG. 4A is an enlarged view of the closed liner box of FIG. 4;

FIG. 5 is a view similar to FIGS. 3 and 4 of a liner filling an inner bin of the trash bin;

FIG. 6 is a view similar to FIG. 5 with a lid assembly installed atop the trash bin with refuse being deposited through the lid assembly in an open configuration and into the liner and inner bin;

FIG. 7 is a view similar to FIG. 6 with the lid assembly in a closed configuration;

FIG. 8 is a view similar to FIG. 5 with a filled liner being removed from the trash bin and a subsequent liner being pulled from the liner roll in the liner box; and

FIG. 9 is a view similar to FIG. 8 with the filled liner fully removed from the trash bin and separated from the subsequent liner which will be expanded to line the trash bin for further refuse collection.

### DETAILED DESCRIPTION OF THE INVENTION

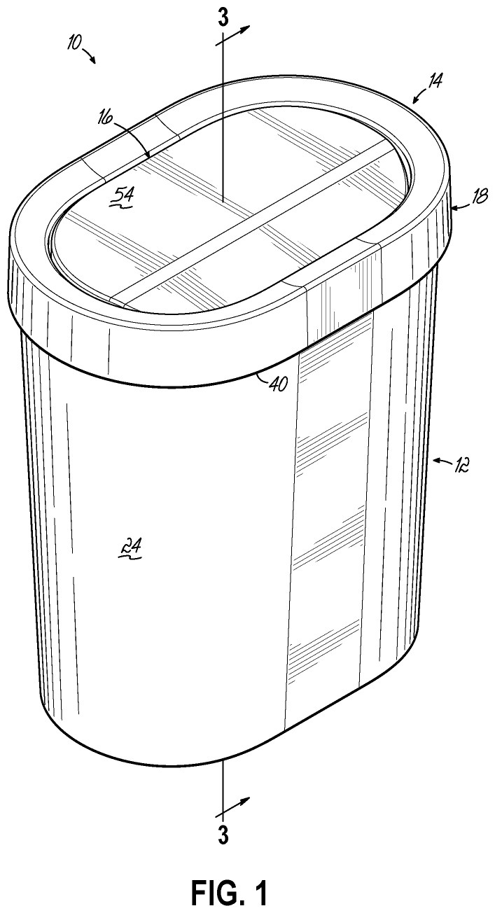

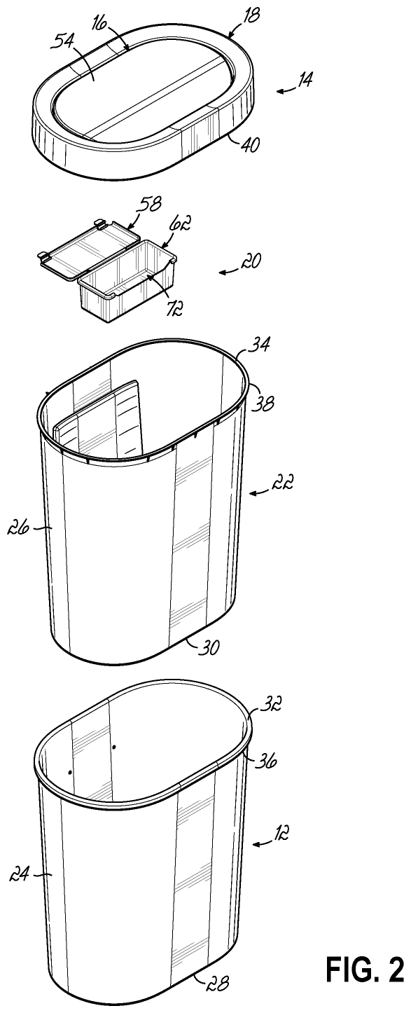

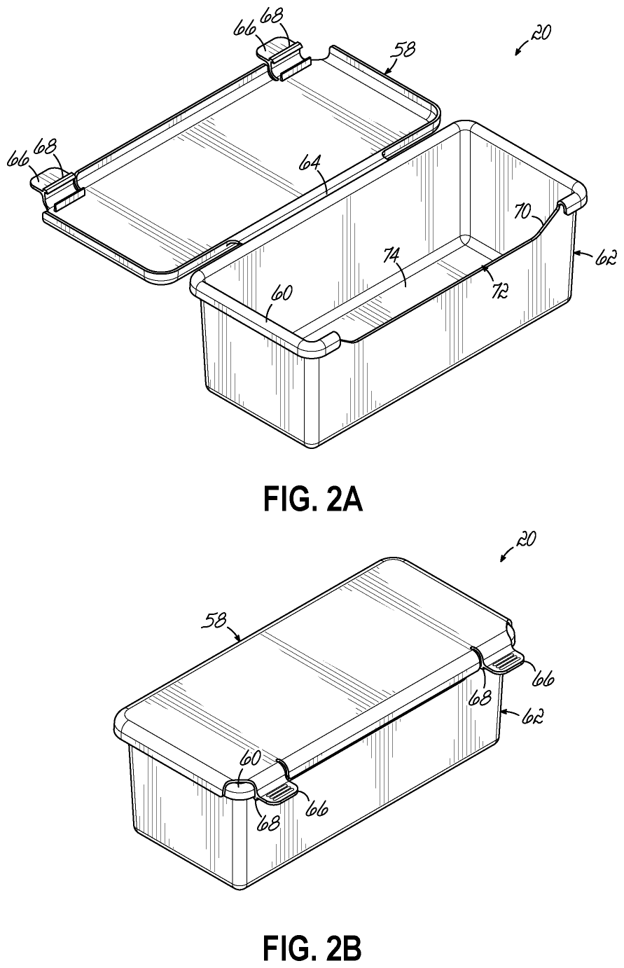

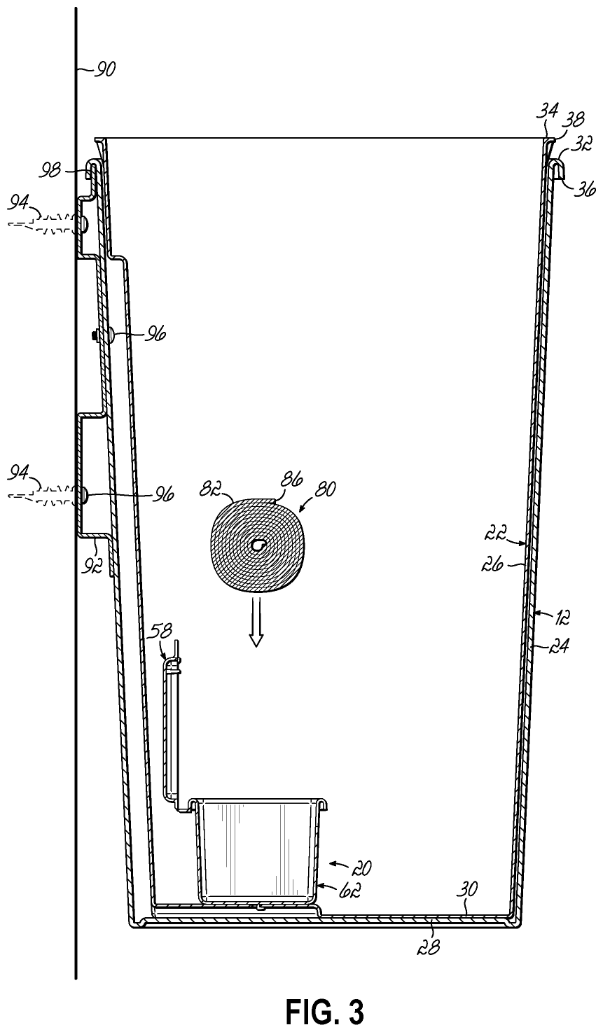

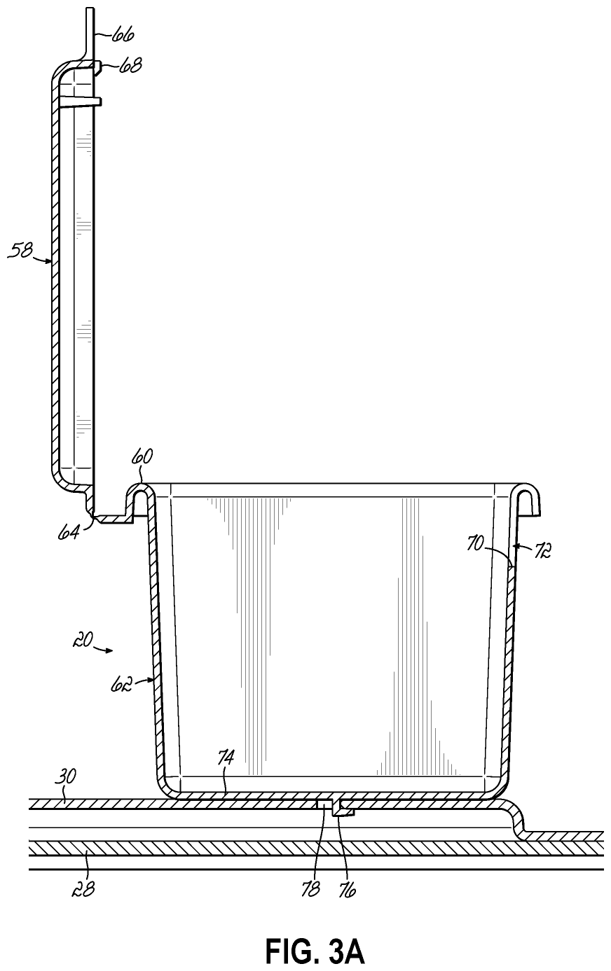

Referring to FIG. 1, one embodiment of a trash bin 10 according this invention is shown. The trash bin 10 includes an outer bin 12 and a lid assembly 14 atop the outer bin 12. The lid assembly 14 includes a generally oval shaped lid 16 suspended in a rim 18 surrounding the lid 16. Additional components of the trash bin 10 according to this embodiment are shown in FIG. 2 including a container in the form of a liner box 20 in various embodiments located within an inner bin 22. The outer and inner bins 12, 22 each have a sidewall 24, 26, respectively, and a bottom wall 28, 30, respectively (FIG. 3). It will be appreciated by one of ordinary skill in the art that the outer and inner bins 12, 22 may have a different shape than those shown in the drawings and may have more than one sidewall, respectively.

The sidewalls 24, 26 of the bins 12, 22 each have an upper edge 32, 34, respectively. Each upper edge 32, 34 has a generally oval shaped out turned lip 36, 38 in this embodiment and the sidewalls 24, 26 have a slight taper down to the generally oval bottom wall 28, 30, respectively. The inner bin 22 is slightly smaller than the outer bin 12 so that it can be nested within the outer bin 12 as shown in FIG. 3 in this embodiment.

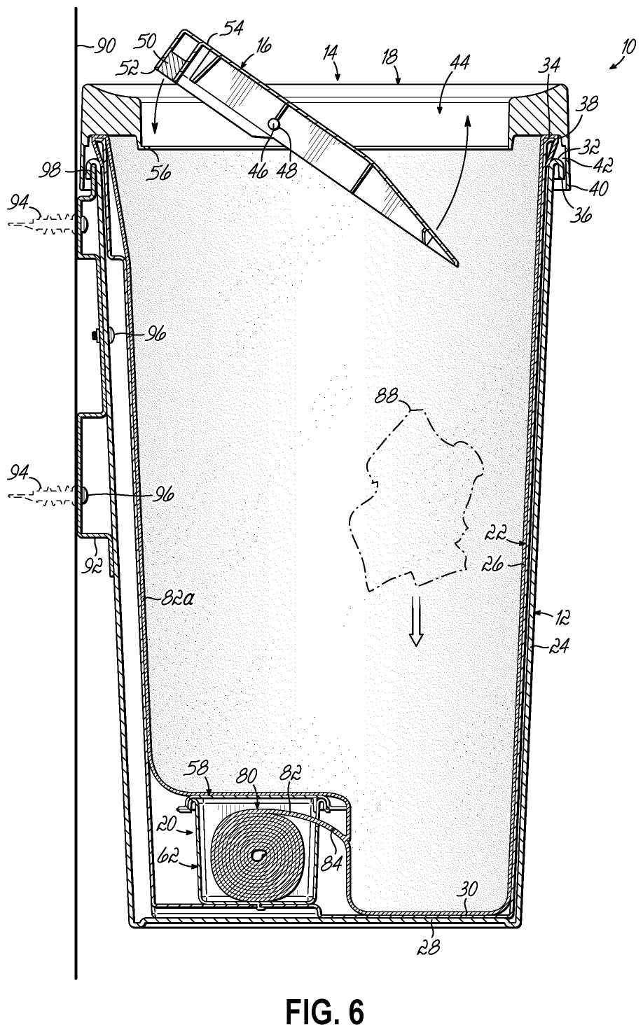

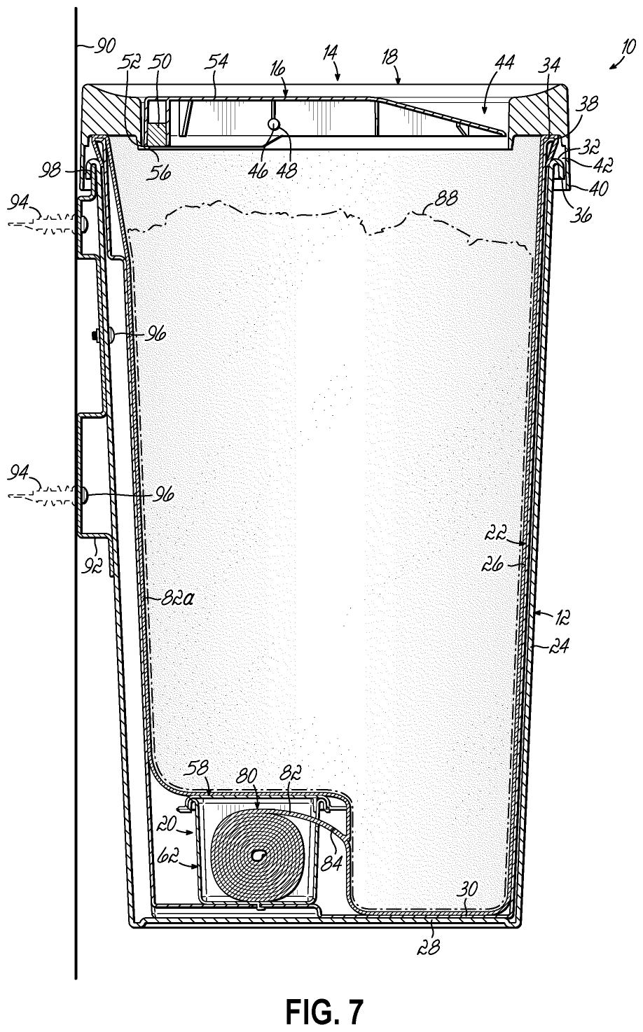

The lid assembly 14 is adapted to be seated atop the upper edges 32, 34 of the bins 12, 22 when the trash bin 10 is in use. A cross-sectional view of the lid assembly 14 is shown in FIGS. 6-7. The rim 18 includes a peripheral downwardly extending hem 40 and adjacent to a downwardly oriented channel 42. When seated atop the bins 12, 22, the channel 42 of the rim 18 rests on the upper edges 32, 34 of the bins 12, 22 and the hem 40 extends downwardly to conceal the lips 36, 38 and provide a more aesthetically pleasing appearance to the trash bin 10. The lid 16 is pivotally mounted within an open mouth 44 defined by the rim 168. The lid 16 is mounted to the rim 168 about a pivot axis 46 which is offset from the midline of the lid 16 so that the lid 16 is biased toward a closed position in the rim 168. A pair of oppositely directed pivot pins 48 (only one of which is shown) extend from opposite ends of the lid 16 and are each seated within openings in the rim 168 to allow for pivotal movement of the lid 16 to and from an open configuration (FIG. 6) and the closed configuration (FIG. 1) with respect to the rim 168. A lid weight 50 is mounted proximate an edge 52 of a first part 54 of the lid 16 to bias the lid 16 toward the closed configuration in which the edge 52 rests upon a shelf 56 projecting from the rim 18 into the mouth 44 (FIG. 7).

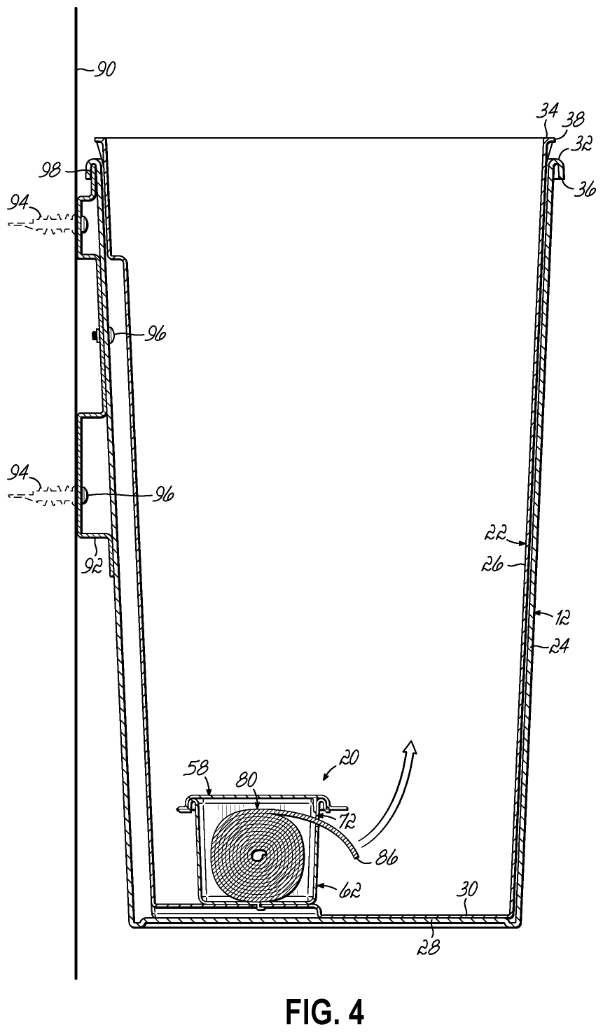

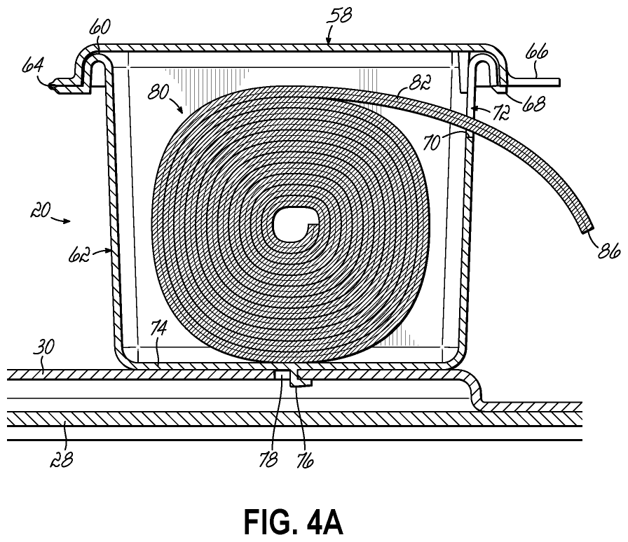

The liner box 20 is shown in FIGS. 2A-2B and includes a lid 58 joined to an upper edge 60 of a hamper 62 by a living hinge 64 in one embodiment. The liner box lid 58 includes a pair of spaced deflectable tabs 66 each having a catch 68 which is adapted to engage the upper edge 60 of the hamper 62 and releasably secure the lid 58 in a closed position on the hamper 62. A recess 70 which forms a slot 72 in the liner box 20 (FIG. 4A) is at the upper edge 60 of the hamper 62 opposite from the living hinge 64. The liner box 20 has a bottom wall 74 with a hook 76 projecting downwardly to engage an aperture 78 in the bottom wall 30 of the inner bin 22 to releasably attach the liner box to the bottom wall 30 (FIG. 3A).

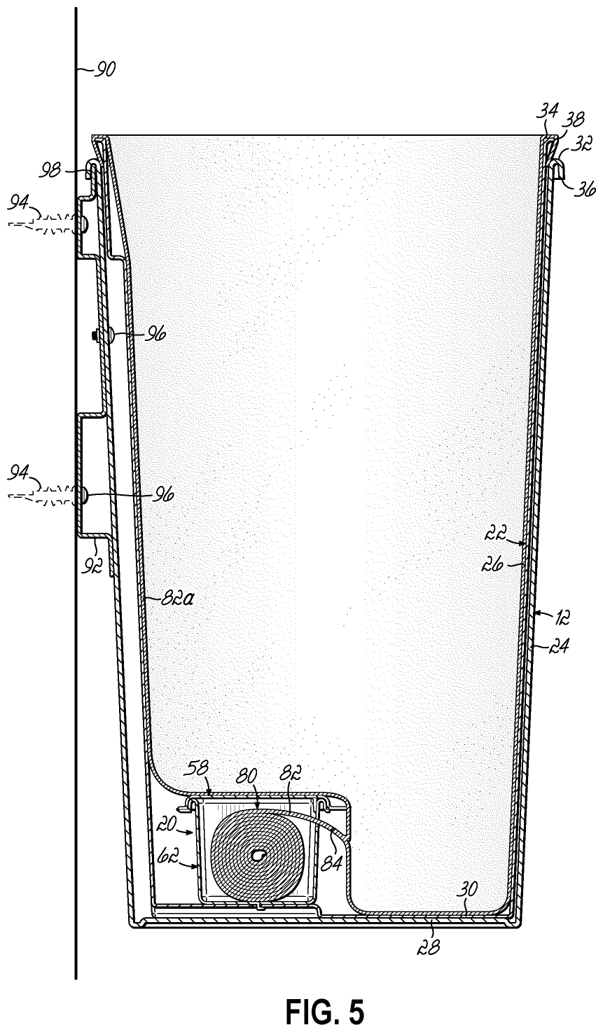

The liner box 20 is adapted to house a liner roll 80 of liner bags 82 as shown in FIG. 3. The liner roll 80 has a number of liner bags 82 serially joined together and rolled into the roll 80 with each bag 82 joined to an adjacent liner bag 82 by a perforation line 84 which enables a user to separate the leading liner bag 82 from the subsequent liner bag 82. Once the liner roll 80 is inserted into the liner box 20, a leading free edge 86 of the leading liner bag 82 may be pulled from the liner roll 80 through the slot 72 in the closed liner box 20 as seen in FIGS. 4 and 4A. As the user continues to pull on the leading liner bag 82, the user may line the interior of the inner bin 22 with the liner bag 82 and secure it in place by tucking the lead free edge 86 around the upper edge 34 of the inner bin 22 and between the upper edge 32 of the outer bin 12 and the sidewall 26 of the inner bin 22 as seen in FIGS. 5-7. Note that when the liner bag 82 is secured in this manner in the trash bin 10, it remains attached to the liner roll 80 housed in the liner box 20 at the bottom of the inner bin 22. The lid assembly 14 may then be seated on the upper edges 32, 34 of the bins 12, 22 as shown in FIGS. 6-7 for the trash bin 10 to receive trash 88 therein.

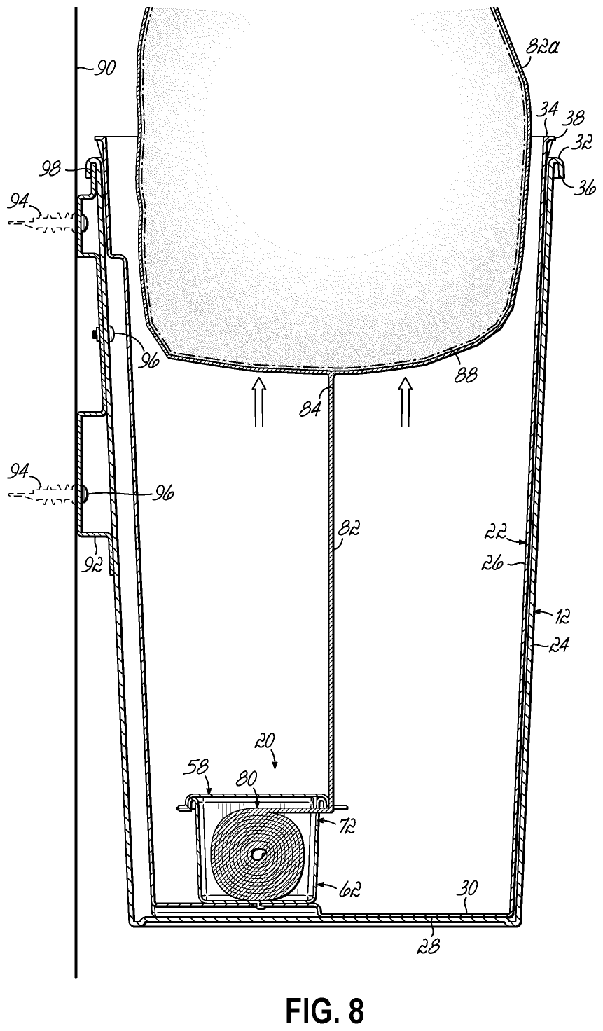

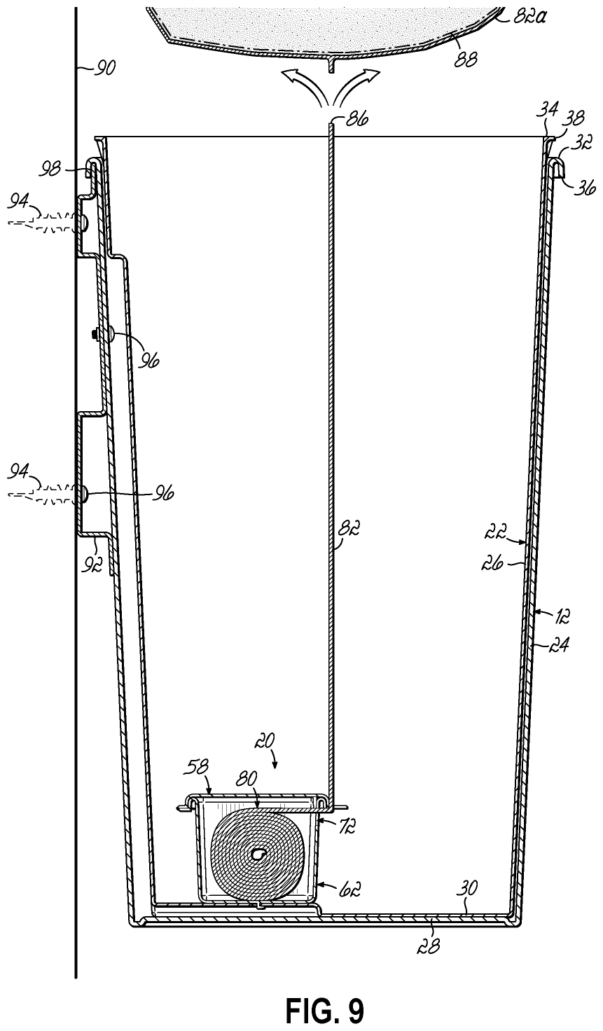

As the trash 88 in the liner bag 82 accumulates and fills the liner bag 82 (FIG. 7), the filled liner bag 82 may be removed from the trash bin 10 by removing the lid assembly 14 from the bins 12, 22 and pulling the filled liner bag 82 upwardly from the bins 12, 22 as shown in FIG. 8. The filled liner bag 82 remains attached to the trailing liner bag 82a as the filled bag 82 is pulled from the bins 12, 22 and the trailing bag 82a is pulled from the liner box 20. As shown in FIG. 9, once the filled liner bag 82 is pulled from the bins 12, 22, the user may separate the filled bag 82 from the trailing bag 82a along the perforation line 84. This may conveniently be accomplished above the upper edges 32, 34 of the bins 12, 22 and not at the bottom of the bins 12, 22 thereby providing more space at a more comfortable height for such tasks. Once the liner bags 82, 82a are separated from one another, the filled bag 82 may be disposed of and the formerly trailing liner bag 82a becomes the leading liner bag 82 and may be expanded and secured in the bins 12, 22 as previously detailed hereinabove according to one aspect of this invention.

Various embodiments of this invention provide distinct advantages over the prior art in addition to those previously described. For example, the liner bag 82 being filled in the trash bin 10 may rip or rupture while it is in the bins 12, 22. If so, trash 88 and associated waste fluids may escape the liner bag 82 and fall/spill into the inner bin 22. However, the remaining liner bags 82 in the liner roll 80 are not fouled or dirtied because they are protected within the liner box 20 according to various embodiments of this invention. Additionally, the nested bins 12, 22 provide for variety of aesthetic options. The outer bin 12 may have a first finish, color or appearance. A user may choose to replace the outer bin 12 for a different look by simply swapping the outer bin 12 for a different one without replacing the remaining components of the trash bin 10.

In various embodiment so this invention, the trash bin 10 is free standing on a floor or other generally horizontal surface. In other embodiments, the trash bin 10 may be mounted to a wall or other generally vertical surface 90 with a mounting bracket 92 as shown in FIGS. 3-8. The mounting bracket 92 may be secured to the wall 90 by screw and anchor combinations 94 and the outer bin 12 may be secured to the mounting bracket 92 by a mounting screw 96 or other appropriate attachment mechanism. Additionally, the lip 36 of the outer bin 12 may be hooked onto an upper edge 98 of the mounting bracket 92 as shown in FIGS. 3-8 to secure the trash bin 10 to the mounting bracket 92 and the wall 90.

From the above disclosure of the general principles of this invention and the preceding detailed description of at least one embodiment, those skilled in the art will readily comprehend the various modifications to which this invention is susceptible. Therefore, we desire to be limited only by the scope of the following claims and equivalents thereof.

We claim:

1. A trash bin comprising:
a bottom wall;
at least one sidewall extending upwardly from the bottom wall and having an upper edge spaced from the bottom wall and defining an opening of the trash bin;
wherein the bottom wall, the at least one sidewall and the upper edge combine to define an interior volume of the trash bin;
a container mounted to one of the bottom wall and the at least one sidewall within the interior volume of the trash bin; and
a supply of serially connected liner bags housed within the container, a leading liner bag of the supply of serially connected liner bags extending from the container to line the bottom wall and the at least one sidewall, the leading liner bag adapted to receive therein refuse inserted through the opening and into the interior volume of the trash bin.

2. The trash bin of claim 1 further comprising:
a lid removably positioned on the upper edge of the at least one sidewall.

3. The trash bin of claim 1 wherein the container is removably mounted to the bottom wall.

4. The trash bin of claim 1 wherein the container further comprises:
a box; and
a box lid hingedly connected to the box.

5. The trash bin of claim 1 further comprising:
a slot in the container through which the supply of serially connected liner bags may be dispensed from the container.

6. The trash bin of claim 1 wherein the container further comprises:
a box;
a box lid hingedly connected to the box; and
a slot located between the box lid and an upper box edge through which the supply of serially connected liner bags may be dispensed from the container.

7. The trash bin of claim 1 wherein the at least one sidewall has a generally oval cross-sectional configuration.

8. The trash bin of claim 1 wherein the supply of serially connected liner bags further comprises a roll of serial connected liner bags.

9. A trash bin comprising:
a bottom wall;
a sidewall extending upwardly from the bottom wall and having an upper edge spaced from the bottom wall and defining an opening of the trash bin;
a lid removably positioned on the upper edge of the sidewall;
wherein the bottom wall, the sidewall and the lid combine to define an interior volume of the trash bin;
a box removably mounted to the bottom wall within the interior volume of the trash bin;
a box lid hingedly connected to the box;
a roll of serial connected liner bag housed within the box, a leading liner bag of the roll of serially connected liner bags extending from the container to line the bottom wall and the sidewall, the leading liner bag adapted to receive therein refuse inserted through the opening and into the interior volume of the trash bin; and
a slot located between the box lid and an upper box edge through which the supply of serially connected liner bags may be dispensed from the box.

10. A trash bin comprising:
a bottom wall;
at least one sidewall extending upwardly from the bottom wall and having an upper edge spaced from the bottom wall and defining an opening of the trash bin;
wherein the bottom wall, the at least one sidewall and the upper edge combine to define an interior volume of the trash bin;
a container mounted to one of the bottom wall and the at least one sidewall within the interior volume of the trash bin, the container adapted to house therein a supply of serially connected liner bags, a leading liner bag of the supply of serially connected liner bags adapted to extend from the container to line the bottom wall and the at least one sidewall, the leading liner bag adapted to receive therein refuse inserted through the opening and into the interior volume of the trash bin.

11. A method comprising the steps of:
placing a supply of serially connected liner bags within a container adapted to be mounted to at least one of a sidewall and a bottom wall of a trash bin;
pulling a leading liner bag of the supply of serially connected liner bags from the container;
lining an interior volume of the trash bin with the leading liner bag;
disposing of trash into the leading liner bag lining the interior volume of the trash bin;
pulling the leading liner bag with trash therein from the interior volume of the trash bin and thereby pulling a second liner bag serially connected to the leading liner bag from the container;
separating the leading liner bag with trash therein from the second liner bag; and
lining the interior volume of the trash bin with the second liner bag.

12. The method of claim ii wherein the separating step is accomplished outside of the interior volume of the trash bin.

13. The method of claim 1 wherein the placing step further comprises placing a roll of serially connected liner bags within the container removably mounted to the bottom wall of the trash bin.

14. The method of claim ii further comprising:
covering the interior volume of the trash bin with a lid.

15. The method of claim 11 wherein the placing step is accomplished when the container is mounted to the bottom wall.

16. The method of claim 11 wherein the placing step is accomplished when the container is not in the interior volume of the trash bin.

17. The method of claim 16 further comprising:
mounting the container with the supply of serially connected liner bags therein to one of the bottom wall and sidewall.

18. The method of claim 11 further comprising:
folding an upper portion of the leading liner bag over an upper edge of the sidewall.

19. The method of claim 11 wherein the second liner bag remains connected to the leading liner bag during the pulling the leading liner bag with trash therein from the interior volume of the trash bin step.

20. The method of claim 11 further comprising:
protecting a remaining supply of liner bags in the container from contamination by the trash.
